(19) United States
(12) Patent Application Publication
(10) Pub. No.: US 2023/0331615 A1
(43) Pub. Date: Oct. 19, 2023

(54) COLOR STREAKED GLASS CONTAINERS USING CULLET INJECTION

(71) Applicant: Owens-Brockway Glass Container Inc., Perrysburg, OH (US)

(72) Inventors: Lawrence Gochberg, Sylvania, OH (US); Scott Cooper, Maumee, OH (US)

(21) Appl. No.: 17/836,198

(22) Filed: Jun. 9, 2022

Related U.S. Application Data
(60) Provisional application No. 63/331,934, filed on Apr. 18, 2022.

(51) Int. Cl. C03B 3/02; C03B 9/14

(52) U.S. Cl. CPC C03B 3/026; C03B 9/14

(57) ABSTRACT

A method of manufacturing a glass container includes melting a batch material, which contains cullet, to produce molten glass having a soda-lime-silica chemical composition. A flow of molten glass is delivered to a forehearth and conditioned within the forehearth, which includes reducing a temperature of the flow of molten glass such that the temperature of the flow of molten glass at an outlet of the forehearth is less than the temperature of the flow of molten glass at an inlet of the forehearth. Additionally, the method involves introducing colored cullet into the flow of molten glass, which produces colored striations within the glass flow. An output of conditioned molten glass is discharged from the forehearth and a glass container is formed from the conditioned molten glass. The glass container has a glass substrate that includes random streaks of color.

The present disclosure is directed to glass container manufacturing and, more specifically, to methods for creating unique streaks of color in glass containers by introducing colored cullet into the glass flow within a forehearth of a glass furnace.

### BACKGROUND

Glass containers are typically manufactured by melting a batch material in a furnace or melter, fining and conditioning the molten glass to remove gas bubbles and thermally homogenize the glass, respectively, and then individually forming the containers in a glass forming machine such as, for example, an individual section forming machine that includes a blank mold and a blow mold. Soda-lime-silica glass-which has a chemical composition that includes 60 wt % to 80 wt % SiO₂, 8 wt % to 18 wt % Na₂O, and 5 wt % to 15 wt % CaO based on the total weight of the glass is the predominant glass from which glass containers are formed. The batch material used to produce molten soda-lime-silica glass includes two components: (1) virgin raw materials such as sand, soda ash, limestone and other materials that contribute one or more SiO₂, Na₂O, CaO, and other desired chemical components to the glass when melted and reacted together, and (2) previously-formed glass known as “cullet.” While cullet may be obtained from a variety of sources, the cullet used in glass container manufacturing operations oftentimes includes post-consumer recycled glass obtained from recycling operations and/or post-industrial recycled glass including waste glass from the same or a different glass plant.

Cullet is substituted for a portion of traditional virgin raw materials in the batch material to lower the amount of energy consumed and reduce the carbon footprint associated with each manufactured glass container. The addition of cullet to the batch material conserves energy since, in cullet, the endothermic chemical reactions required to produce glass have already been completed, meaning that less energy is required to remelt cullet than is required to melt the quantity of constituent virgin raw materials needed to produce a corresponding amount of molten glass. The use of cullet also preserves resources; indeed, any cullet that is added to the batch material necessarily conserves virgin raw materials, which is aided by the fact that the cycle of forming, recycling, and remelting glass can occur infinitely. Additionally, remelting cullet reduces the amount of carbon dioxide produced for a given quantity of glass since less virgin raw materials, which tend to be carbonates that release CO₂ when melted, are included in the batch material. Still further, the inclusion of cullet in the batch material lowers the melting temperature of the batch material and renders the resultant molten glass less corrosive. In that regard, the operational life of certain equipment, most notably the furnace or melter, can be extended.

Glass manufacturers may wish to visibly mark glass containers that have been formed from a batch material containing cullet or, perhaps more specifically, from a batch material that includes some minimum amount of cullet. In this way, the purchasers of the glass containers and the general public at large can easily discern that the containers have been manufactured in an ecologically-friendly way. In the present disclosure, a glass container manufacturing process is disclosed that results in the glass substrate of an as-formed glass container having randomized streaks of color. These streaks of color uniquely indicate that the glass container has been formed at least in part from cullet and serve to visually distinguish the glass container from those produced by other manufacturers. And, since the streaks of color are a permanent and intrinsic feature of the glass, the color streaks cannot be tampered with or removed from the glass container after the container leaves the manufacturing plant. The visually distinctive and fashionable streaks of color are created from cullet that is separate from the cullet included in the batch material. As such, the process of creating the streaks of color does not compromise the eco-friendly nature of the glass container.

### SUMMARY OF THE DISCLOSURE

The present disclosure relates to a method for manufacturing glass containers that include random streaks of color. The colored streaks are deliberately integrated into the glass substrates of the containers to signify that the glass has been formed from a batch material that includes cullet. The colored streaks, which can assume any of a wide variety of contours and colors, are created within the glass containers by introducing colored cullet into the flow of molten glass moving through a forehearth that receives molten glass from an upstream furnace or melter and discharges conditioned molten glass to downstream container forming equipment. The colored cullet may be introduced in solid form, in a molten form, or a combination of solid form and a molten form. And, regardless of the form added, the colored cullet produces colored striations within the conditioned molten glass leaving the forehearth that ultimately manifest themselves as streaks of color within glass containers formed from the conditioned molten glass. In addition to creating the streaks of color, the cullet added to the flow of molten glass absorbs heat and cools the flow of molten glass in the forehearth, which can reduce the flow of cooling air that needs to be fed into the forehearth in order to condition the glass to a certain viscosity and thermal homogeneity.

The present disclosure embodies a number of aspects that can be implemented separately from or in combination with each other to provide a method for producing glass. According to one embodiment of the present disclosure, a method of manufacturing a glass container includes several steps. One step of the method involves melting a batch material, which contains cullet, to produce molten glass having a soda-lime-silica chemical composition. Another step of the method involves delivering a flow of molten glass to a forehearth that comprises an elongated housing and a glass feeder appended to the elongated housing. The elongated housing defines a conditioning compartment, and the flow of molten glass flows through the conditioning compartment of the forehearth from an inlet to an outlet along a flow direction and then enters a spout chamber of the glass feeder. Yet another step of the method involves conditioning the flow of molten glass within the conditioning compartment of the forehearth including reducing a temperature of the flow of molten glass such that the temperature of the flow of molten glass at the outlet of the conditioning compartment is less than the temperature of the flow of molten glass at the inlet of the conditioning compartment. Still another step of the method involves introducing colored cullet into the flow of molten glass, which produces colored striations that do not fully mix and assimilate into the flow of molten glass. Another step of the method involves discharging an output of conditioned molten glass from the glass feeder of the forehearth. And yet another step of the method involves forming a glass container from the output of conditioned molten glass. The glass container comprises a glass substrate that defines the shape of the container and includes random streaks of color.

According to another aspect of the present disclosure, a method of manufacturing a glass container includes several steps. One step of the method involves introducing a batch material, which contains cullet, into a melting chamber of a glass furnace. The batch material is, specifically, introduced onto a molten glass bath that comprises soda-lime-silica glass and melts into the molten glass bath. Yet another step of the method involves flowing the molten glass bath from the melting chamber of the glass furnace to a fining chamber of the glass furnace through a submerged throat. Still another step of the method involves delivering a flow of molten glass from the fining chamber of the glass furnace to a forehearth connected to the glass furnace. The forehearth includes an elongated housing and a glass feeder appended to the elongated housing. The elongated housing defines a conditioning compartment, and the flow of molten glass flows from an inlet of the conditioning compartment to an outlet of the conditioning compartment along a flow direction and then enters the glass feeder. Another step of the method involves conditioning the flow of molten glass within the conditioning compartment including reducing a temperature of the flow of molten glass such that the temperature of the flow of molten glass at the outlet of the conditioning compartment is less than the temperature of the flow of molten glass at the inlet of the conditioning compartment. Another step of the method involves introducing colored cullet into the flow of molten glass. The colored cullet comprises solid cullet particles that produce colored striations within the flow of molten glass. Still another step of the method involves discharging at least one gob of conditioned molten glass from the glass feeder of the forehearth. And still another step of the method involves forming a glass container from the gob of conditioned molten glass. The glass container comprises a glass substrate that defines the shape of the container and includes and axially-closed base and a circumferential wall extending from a periphery of the axially-closed base. Additionally, at least the circumferential wall of the glass substrate includes integral random streaks of color.

### BRIEF DESCRIPTION OF THE DRAWINGS

The disclosure, together with additional objects, features, advantages, and aspects thereof, will be best understood from the following description, the appended claims, and the accompanying drawings, in which:

FIG. 1 is a cross-sectional view of a glass container that includes random streaks of color according to practices of the method described in the present disclosure;

FIG. 2 is a perspective view of a glass container that includes random streaks of color according to practices of the method described in the present disclosure;

FIG. 3 is a cross-sectional view of a glass-making furnace that may be used according to practices of the method described in the present disclosure;

FIG. 4 is a magnified view of a forehearth that is connected to the glass-making furnace depicted in FIG. 3 and may be used according to practices of the method described in the present disclosure;

FIG. 5 is a cross-sectional view of the forehearth illustrated in FIGS. 3-4 taken along section line 5-5 (FIG. 4) according to one embodiment of the present disclosure; and

FIG. 6 is a flow chart that represents a process for forming glass containers from an outflow of conditioned molten glass discharged from the forehearth depicted in FIGS. 3-5 according to practices of the method described in the present disclosure.

### DETAILED DESCRIPTION

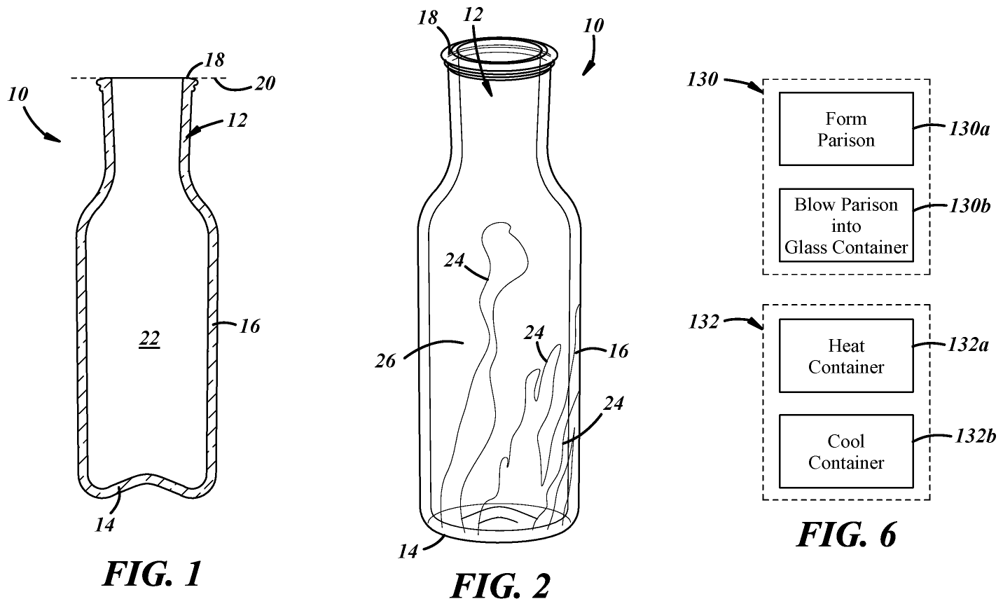

Referring now to FIGS. 1-2, a glass container 10 is shown that includes a glass substrate 12 that defines the shape of the container 10. The glass substrate 12 includes an axially-closed base 14 and a circumferential wall 16. The circumferential wall 16 extends from the axially-closed base 14 and terminates in a mouth 18 that defines an entrance plane 20 to a containment space 22 defined by the axially-closed base 14 and the circumferential wall 16. To identify the glass container 10 as being one that is formed from a batch material containing cullet, the container 10 is marked with random streaks of color 24 that meander through at least a portion of the circumferential wall of the glass substrate 12. The random streaks of color 24 are essentially colored portions of the glass substrate 12 that are integral with and contrast visually with a native portion 26 of the glass substrate 12 that does not contain the streaks of color 24. The streaks of color 24 can be the same color or different colors and, due to the fact that the streaks or color 24 are an intrinsic feature of the glass—meaning the streaks of color 24 cannot be indestructibly separated from the native portion 26 of the glass substrate 12—the streaks of color 24 constitute permanent and unique visual markings that are entirely within the control of the glass container manufacturer. As will be further explained below, cullet that is separate from the cullet included in the batch material is used to create the streaks of color 24.

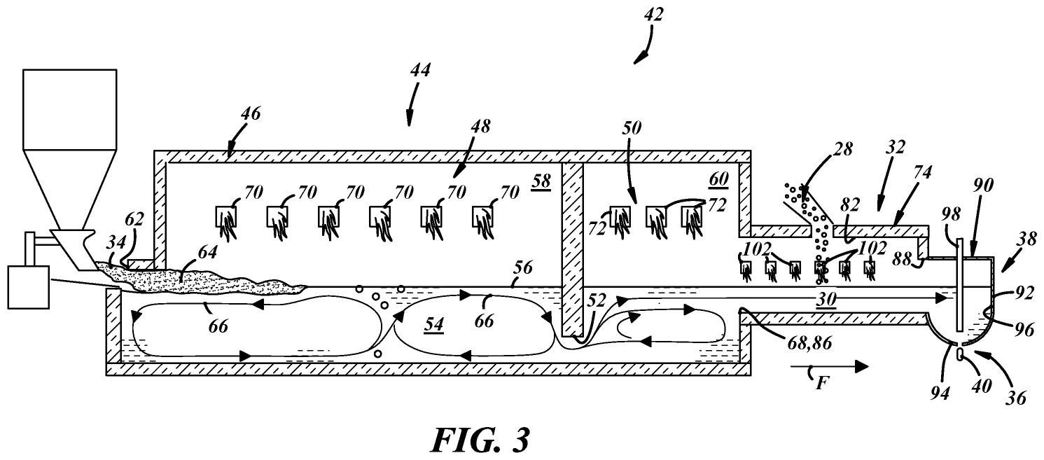

The disclosed method is depicted in FIGS. 3-6 and involves introducing colored cullet 28 into a flow of molten glass 30 moving through a forehearth 32. The flow of molten glass 30 traveling through the forehearth 32 is produced from a batch material 34 (FIG. 3) upstream of the forehearth 32 in a furnace or melter. As the flow of molten glass 30 flows through the forehearth 32, the temperature of the flow of molten glass 30 increases and its viscosity decreases, and the flow of molten glass 30 is thermally homogenized, in a process known as glass conditioning. As a result of such conditioning, an output conditioned molten glass 36 is discharged from the forehearth 32, preferably from a glass feeder 38 as at least one gob of conditioned molten glass 40, and is delivered to downstream glass container forming machines. When the colored cullet 28 is introduced into the flow of molten glass 30, the colored cullet melts if not already in molten form (i.e., if introduced as solid particles) and the molten cullet flows, but does not fully mix and assimilated into the glass 30 before being discharged from the forehearth 32 within the output of conditioned molten glass 36. The non-assimilated flows of melted colored cullet forms colored striations within the flow of molten glass 30 and the output of conditioned molten glass 36, which eventually become the random streaks of color 24 within the glass container 10 formed from the conditioned molten glass 34.

Referring now specifically to FIG. 3, one particular embodiment of a glass-making system 42 that includes a continuous glass-making furnace 44 and the forehearth 32 is shown. The furnace 44 includes a housing 46 constructed from refractory materials that defines a melting chamber 48, a fining chamber 50, and a throat 52 that separates the melting and fining chambers 48, 50. A molten glass bath 54 having a glass level surface 56 partially fills the melting and fining chambers 48, 50, and fully fills the throat 52, and the batch material 34 is introduced into the molten glass bath 54 within the melting chamber 48 to feed the glass bath 54 with glass. The molten glass bath 54 flows from the upstream melting chamber 48 and into the downstream fining chamber 50 through the throat 52, which is submerged below the level surface 56 of the molten glass bath 54 and establishes fluid communication between the melting and fining chambers 48, 50. As the molten glass bath 54 only partially fills the melting and fining chambers 48, 50, a melting chamber combustion zone 58 is present within the melting chamber 48 above the molten glass bath 54 and an fining chamber combustion zone 60 is present within the fining chamber 50 above the molten glass bath 54. A relatively large quantity of the molten glass—typically 30 tons to 1000 tons—is contained in the furnace 10 to support a glass residence time within the melting and fining chambers 48, 50 that ranges from 8 hours to 72 hours. The molten glass that comprises the molten glass bath 54 may be soda-lime-silica glass.

A batch inlet 62 is defined in the housing 46 and provides an entrance to the melting chamber 48 for the delivery of the batch material 34 onto the molten glass bath 54. The batch material 34 is distributed over the glass level surface 56 of the molten glass bath 54 as a batch blanket 64 that melts and reacts to form glass that mixes into the molten glass bath 54 over time with the aid of convective flow currents 66. A glass outlet 68 is also defined in the housing 46 and provides an exit from the fining chamber 50 through which the flow of molten glass 30 is pulled from the molten glass bath 54 to supply the forehearth 32. Because gas bubbles are removed from the molten glass bath 54 in the melting chamber 48 and the fining chamber 50 in a process known as “fining,” the flow of molten glass 30 supplied to the forehearth 32 is typically considered “fined” glass that meets a prescribed specification for bubble content.

A plurality of overhead burners 70 is mounted in the housing 46 within the melting chamber 48. Each of these overhead burners 70 discharges a combustion flame into the melting chamber combustion zone 58 above the molten glass bath 54. These combustion flames heat the glass bath 54 to facilitate melting and reacting of the batch material 34. During operation of the glass-making furnace 44, and when the molten glass bath 54 comprises soda-lime-silica glass, the molten glass bath 54 may be maintained within a temperature range of 1200° C. to 1550° C. in the melting chamber 48. Similarly, a plurality of overhead burners 72 may be mounted in the housing 46 within the fining chamber 50. Each of these overhead burners 72 discharges a combustion flame into the refining chamber combustion zone 60 above the molten glass bath 54. These combustion flames allow the molten glass bath 54 to cool at a controlled rate in the fining chamber 50 to help facilitate the ascension and removal of entrained gas bubbles from the glass. During operation of the glass-making furnace 44, the molten glass bath 54 may be maintained within a temperature range of 1450° C. to 1150° C. in the fining chamber 50.

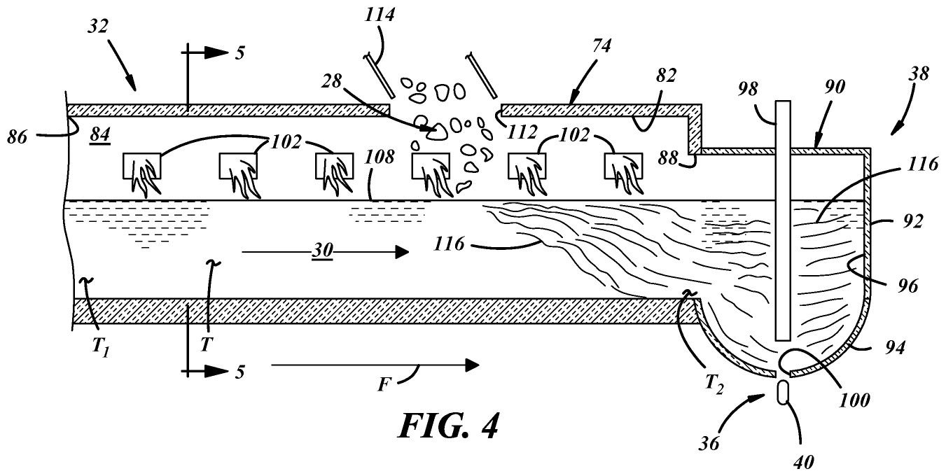

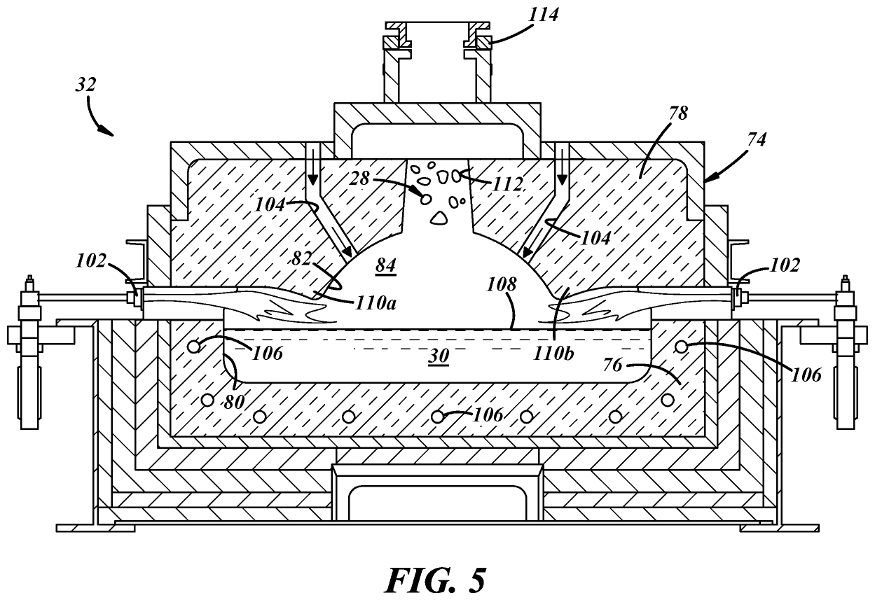

The forehearth 32 is fluidly connected to the fining chamber 50 of the glass-making furnace 44 and receives the flow of molten glass 30 either directly or indirectly from the glass outlet 68. The forehearth 32 includes an elongated housing 74 and the glass feeder 38 appended to the housing 74. The elongated housing 74 comprises a trough 76 and a roof 78 as shown best in FIGS. 4-5. The trough 76 defines an elongated channel 80 along which the flow of molten glass 30 flows in a flow direction F, and the trough 76 and the roof 78 together define an interior conditioning compartment 82 that includes the elongated channel 80 and an open space 84 above the flow of molten glass 30. The elongated housing 74 further defines an inlet 86 to and an outlet 88 from the conditioning compartment 82 that are spaced apart along the flow direction F of the elongated channel 80. The flow of molten glass 30 is received from the furnace 44 into the conditioning compartment 82 of the forehearth 32 through the inlet 86, flows from the inlet 86 to the outlet 88 of the conditioning compartment 82 along the flow direction F, and exits the conditioning compartment 82 through the outlet 88.

Upon exiting the conditioning compartment 82, the flow of molten glass enters the glass feeder 38 of the forehearth 32, which delivers the output of conditioned molten glass 36. The glass feeder 38 includes a spout 90 having a spout bowl 92 and a bottom orifice plate 94 that together define a spout chamber 96. The spout chamber 96 fluidly communicates with the conditioning compartment 82 of the forehearth 32 via the outlet 88 and the portion of the flow of molten glass 30 contained within the spout chamber 96 is conditioned molten glass as it has already navigated through the conditioning compartment 82. The spout 90 also includes at least one plunger 98 that reciprocates relative to the orifice plate 94 to control the flow of conditioned molten glass through an aligned orifice 100 in the orifice plate 94 as a stream of conditioned molten glass. The stream of conditioned molten glass may be sheared just below the orifice plate 94 such that the output of conditioned molten glass 36 discharged from the forehearth 32 is in the form of at least one individual gob of conditioned molten glass 40. Each glass gob 40 discharged from the glass feeder 38 of the forehearth 32 can be formed into a glass container.

The flow of molten glass 30 is conditioned as it flows through the elongated channel 80 by coordinated heating and cooling. As shown best in FIGS. 4-5, the forehearth 32 may include plurality of overhead burners 102 mounted in burner blocks contained in the roof 78 of the elongated housing 74. These burners 102 are spaced apart along the flow direction F of the flow of molten glass 30 and are configured to laterally discharge combustion flames into the open space 84 of conditioning compartment 82 above the flow of molten glass 30. Additionally, the forehearth 32 may include air ducts 104 that deliver cooling air into the open space 84 of the conditioning compartment 82 above the flow of molten glass 30 in any of a variety of flow patterns. Heat exchange conduits 106 that communicate a heating fluid or a cooling fluid may also be defined in the trough 76 to help control the temperature of the flow of molten glass 30. In operation, the flow of molten glass 30 is hottest in the center towards a top surface 108 of the glass since that portion of the flow of molten glass 30 is furthest from the walls of the trough 76. Accordingly, to help decrease temperature gradients and thermally homogenize the glass, the plurality of overhead burners 102 are usually directed to heat the portions of the flow of molten glass 30 that flow adjacent to the walls of the trough 76, and the cooling air is directed to simultaneously cool the central portion of the flow of molten glass 30.

As part of conditioning the flow of molten glass 30, and as depicted in FIG. 4, the forehearth 32 is operated to reduce a temperature T of the flow of molten glass 30 along the flow direction F from a first temperature T₁ at the inlet 86 of the conditioning compartment 82 to a second temperature T₂ at the outlet 88 of the conditioning compartment 82 and within the spout chamber 96 to achieve a glass viscosity appropriate for downstream glass forming operations. The first temperature T₁ of the flow of molten glass 30 may range from 1100° C. to 1450° C. and the second temperature T₂ of the flow of molten glass 30 may range from 1050° C. to 1200° C. The flow of molten glass 30 is more thermally homogenized (i.e., has a smaller temperature gradient) at the second temperature T₂. To help efficiently reduce the temperature of and thermally homogenize the flow of molten glass 30, a pair of laterally spaced projections 110a, 110b that run parallel to the flow direction F may extend downwardly from the roof 78 of the elongated housing 74 to divide the open space 84 above the flow of molten glass 30 into a central section and two side sections. The central and two side sections, in turn, help ensure that heat is delivered from the burners 102 and cooling air is delivered from the air ducts 104, respectively, to the corresponding portions of the flow of molten glass 30.

The colored cullet 28 may be introduced into the forehearth 32 either in the elongated housing 74 or the glass feeder 38. For example, in one embodiment, as auxiliary inlet 112 is additionally defined in the elongated housing 74 of the forehearth 32 between the inlet 86 and the outlet 88 to allow the colored cullet 28 to be selectively introduced into the flow of molten glass 30. The auxiliary inlet 112 may be a single opening that provides access to the conditioning compartment 82 and the flow of molten glass 30 or it may collectively be several such openings. The colored cullet 28 may be added into the flow of molten glass 30 as solid particles or as molten cullet that has been pre-melted outside of the forehearth 32. The auxiliary inlet 112 receives the colored cullet 28 from an auxiliary feeder that can meter solid particulate material or molten cullet. The quantity of the colored cullet 28 supplied by the auxiliary feeder may be delivered to a guide 114, which is arranged in feeding communication with or extends through the auxiliary inlet 112 to introduce the colored cullet 28 into the flow of molten glass 30. The colored cullet 28 may be unicolored or multicolored depending on the desired appearance of the streaks of color 24.

The auxiliary inlet 112 is located in the forehearth 32 so that the colored cullet will flow but will not become fully mixed and assimilated into the flow of molten glass 30. The colored cullet is flowable, typically at a viscosity of 10³ Pa·s or less, either by being premelted into molten cullet prior to being entered into the forehearth 32 or by being added as solid particles into the flow of molten glass 30 and then melting within the glass into molten cullet. Here, in the embodiment shown in FIGS. 3-5, the colored cullet introduced into the flow of molten glass 30 within the conditioning compartment 82 of the forehearth 32 includes solid cullet particles. Because solid cullet particles are included in the colored cullet 28, the auxiliary inlet 112 is positioned so that the solid cullet particles have enough time to melt into molten cullet and flow within the flow of molten glass 30 but not so much time that the molten cullet disbands and becomes assimilated into the flow of molten glass 30 such that it loses its distinctive band. If the colored cullet 28 includes premelted molten cullet, the colored cullet can be introduced into the flow of molten glass 30 closer to the glass feeder 38 since the premelted molten cullet would not have to initially melt like the solid cullet particles. In fact, in one embodiment, the colored cullet, if comprised of premelted molten cullet, can even be introduced into the flow of molten glass 30 contained in the spout chamber 96; that is, the premelted molten cullet may be introduced directly into the conditioned molten glass portion of the flow of molten glass 30 within the spout chamber 96 of the spout 90.

The melting (if necessary due to some or all of the colored cullet being in solid form) and flowing of the colored cullet 28 produces colored striations 116 within the flow of molten glass 30. These colored striations 116 are maintained in the conditioned glass within the spout chamber 96 as well as the output of conditioned molten glass 36 discharged from the forehearth 32. When the glass container 10 is formed from the gob of conditioned molten glass 40 and cooled to a temperature below the glass-transition temperature of the glass, the colored striations 116 become fixed within the glass substrate 12 of the container 10 as the visibly-perceptible streaks of color 24. Apart from creating the streaks of color 24 in the glass container 10, the colored cullet 28 may absorb heat from the flow of molten glass 30, especially if the colored cullet 28 is added as solid particles that absorb heat when melting and becoming less viscous, which can in turn reduce the quantity of cooling air that needs to be input to the forehearth 32 to properly condition the flow of molten glass 30 as it moves forward down the elongated channel 80 of the trough 76. The best opportunity for realizing a savings in the demand for cooling air occurs when the colored cullet is introduced into the middle third of the top surface 108 of the flow of molten glass 30 since, as discussed above, the central portion of the glass is where the cooling air is commonly directed.

During operation of the glass-making system 42, the batch material 34 is introduced into the melting chamber 48 of the furnace 44 and is distributed over the glass level surface 56 of the molten glass bath 54 as the batch blanket 64. The batch material 34 melts, flows, and mixes into the molten glass bath 54 as assisted by the convective flow currents 66 that are present within the molten glass bath 54 and the radiant heat provided by the overhead burners 70 within the melting chamber 48. The batch material 34 is formulated to produce soda-lime-silica glass, which has a chemical composition that includes 60 wt % to 80 wt % SiO₂, 8 wt % to 18 wt % Na₂O, and 5 wt % to 15 wt % CaO, or more narrowly 70 wt % to 75 wt % SiO₂, 12 wt % to 15 wt % Na₂O, and 9 wt % to 13 wt % CaO, based on the total weight of the glass. In addition to SiO₂, Na₂O, and CaO, the chemical composition of soda-lime-silica glass may include other oxide and non-oxide materials including aluminum oxide (Al₂O₃), magnesium oxide (MgO), potassium oxide (K₂O), carbon, sulfates, nitrates, fluorines, chlorines, and/or elemental or oxide forms of one or more of iron, arsenic, antimony, selenium, chromium, barium, manganese, cobalt, nickel, sulfur, vanadium, titanium, lead, copper, niobium, molybdenum, lithium, silver, strontium, cadmium, indium, tin, gold, cerium, praseodymium, neodymium, europium, gadolinium, erbium, and uranium. Regardless of what other oxide and/or non-oxide materials are present in the soda-lime-glass besides SiO₂, Na₂O, and CaO, the sum total of those additional materials is preferably 10 wt % or less, or more narrowly 5 wt % or less, based on the total weight of the glass.

The batch material 34 may be a physical mixture of virgin raw materials and, optionally, cullet (i.e., recycled glass) and/or other glass precursor oxides that provide a source of SiO₂, Na₂O, and CaO in the correct proportions along with any of the other components of the glass listed below in Table 1. For example, the batch material 34 may include raw materials such as quartz sand (crystalline SiO₂), soda ash (Na₂CO₃), and limestone (CaCO₃) in the quantities needed to provide the requisite proportions of SiO₂, Na₂O, and CaO, respectively. Other raw materials may of course be included in the batch material 34 to contribute one or more of SiO₂, Na₂O, CaO, and possibly other oxide and/or non-oxide materials. These other virgin raw materials may include feldspar, dolomite, and calumite slag. The batch material 34 may include anywhere from 10-90 wt % cullet, with an amount ranging from 10 wt % to 70 wt % being typical, to help conserve energy and reduce the carbon footprint associated with each manufactured glass container. Additionally, the batch material 34 may include secondary materials that provide the soda-lime-silica glass with colorants, decolorants, and/or redox agents, and in some instances may include chemical fining agents. And while the glass produced by melting the batch material 34 satisfies the compositional constraints of soda-lime-silica glass, the exact recipe of the batch material 34 may vary depending on the virgin raw materials used and the proportion of cullet included in the batch material 34 relative to the other materials.

TABLE 1
Chemical Composition of Soda-Lime-Silica Glass

| Component | Weight % | Raw Material Sources |
|---|---|---|
| SiO₂ | 60-80 | Quartz sand |
| Na₂O | 8-18 | Soda ash |
| CaO | 5-15 | Limestone |
| Al₂O₃ | 0-3 | Nepheline Syenite, Feldspar |
| MgO | 0-5 | Magnesite |
| K₂O | 0-3 | Potash |
| Fe₂O₃ + FeO | 0-0.08 | Iron is a contaminant |
| MnO₂ | 0-0.3 | Manganese Dioxide |
| SO₃ | 0-0.5 | Salt Cake, Slag |
| Se | 0-0.0005 | Selenium |
| F | 0-0.5 | Fluorines are a contaminant |

The molten glass bath 54 flows from the melting chamber 48 to the fining chamber 50 through the submerged throat 52. As the molten glass bath 54 flows through the furnace 44, gas bubbles that are released into the glass when the batch material 34 is melted are removed through fining processes. The fining process begins in the melting chamber 48 as the larger of the entrained gas bubbles quickly ascend through the molten glass bath 54 and burst when the reach the glass level surface 56. This process may be augmented by fining agents that are optionally included in the batch material 34. The concentration of entrained gas bubbles in the molten glass bath 54 is further reduced in the fining chamber 50 on the other side of the throat 52. In the fining chamber 50, entrained gas bubbles continue to rise out of the molten glass bath 54 and glass bath 54 is also slowly cooled as the glass flows towards the forehearth. This cooling increases the solubility of certain gasses within the glass, allowing smaller entrained gas bubbles that do not escape the molten glass bath 54 to dissolve back into the glass. The removal of gas bubbles from the molten glass bath 54 is desired and promoted by thermal and/or chemical assistance to ensure the finished glass container 10 does not contain commercially unacceptable bubbles within the glass substrate 12.

As the batch material 34 is fed to the furnace 44 and the molten glass bath 54 flows through the melting and fining chambers 48, 50, the flow of molten glass 30 is pulled into the forehearth 32, more specifically the conditioning compartment 82, from the fining chamber 50. The flow of molten glass 30 flows through the conditioning compartment chamber 82 along the elongated channel 80 from the inlet 86 to the outlet 88. The flow of molten glass 30 is reduced in temperature along the way from its first temperature T₁ at the inlet 86 to its second temperature T₂ at the outlet 88 by the combined application of heat from the plurality of overhead burners 102 and the flow of cooling air from the air ducts 104 and becomes more thermally homogenized as well. At the outlet 88 of the conditioning compartment 82 of the elongated housing 74, the flow of molten glass 30, which at this point comprises conditioned molten glass, enters the spout chamber 96 of the spout 90 of the forehearth 32.

The colored cullet 28 is introduced into the flow of molten glass 30 moving through the forehearth 32 via the auxiliary inlet 112 in the embodiment shown in FIGS. 3-5. The colored cullet 28 produces the colored striations 116 within the flow of molten glass 30, which are shown generically in FIG. 4. If the colored cullet 28 includes solid cullet particles, for example, those particles melt to form molten cullet that flows but does not fully mix and assimilate into the flow of molten glass 30 to produce the colored striations 116, as described above. If the colored cullet 28 includes premelted molten cullet, on the other hand, the molten cullet simply flows but does not fully mix and assimilate into the flow of molten glass 30 to produce the colored striations 116. The color of the colored striations 116 is controllable and is derived from the color(s) of the colored cullet 28 and the color of the glass within the flow of molten glass 30. The particular color of the colored striations 116—and the color of the streaks of color 24 that are eventually created in the glass container 10—can be managed by presorting the cullet particles included in the colored cullet 28 by particle size and color so that the introduction of the colored cullet 28 into the flow of molten glass 30 will predictably result in striations 116 of an expected color when integrated into a bulk color associated with the flow of molten glass. At the outlet 88 of the conditioning compartment 82, the flow of molten glass 30 enters the spout chamber 96 of the spout 90 and, within the spout chamber 96, provides a source of conditioned molten glass. The reciprocating movement of the plunger 104 controls the flow of a stream of conditioned molten glass out of the spout 90 through the orifice plate 100 and the conditioned molten glass gob 40 that is sheared from the stream of conditioned molten glass may be formed into the glass container 10.

The glass container 10 may be formed from the conditioned molten glass gob 40 by a standard container forming process such as the one represented in FIG. 6. The container forming process referred to in FIG. 6 includes a forming step 130 and an annealing step 132. In the forming step 130, the conditioned molten glass gob 40 is delivered into a blank mold of a glass container forming machine. Once in the blank mold, the conditioned molten glass gob 40, which is comprised of conditioned molten glass having the colored striations 116, is pressed or blown in substep 130a into a parison or preform that includes a tubular wall. The parison is then transferred from the blank mold into a blow mold of the glass container forming machine. Once the parison is received in the blow mold, the blow mold is closed and the parison is rapidly outwardly blown in substep 130b into the glass container 10 with the shape and contour of the glass substrate 12 matching the contour of the mold cavity. The parison is typically outwardly blown into the glass container 10 using a compressed gas such as compressed air. Other approaches may of course be implemented to form the glass container 10 in the forming step 130 besides the press-and-blow and blow-and-blow forming techniques including, for instance, compression or other molding techniques.

The glass container 10 is then removed from the blow mold and placed on a conveyor or other transport device. The glass container 10 is then reheated, if necessary, and cooled at a controlled rate in the annealing step to relax thermally-induced strain within the glass substrate 12. The glass container 10 may be annealed in an annealing lehr or by another suitable approach. During annealing, the glass container 10 is heated in a reheating substep 132a to a temperature above the annealing point of the soda-lime-silica glass, if necessary, and is then slowly cooled in a cooling substep 132b at a rate of 1° C./min to 10° C./min to a temperature below the strain point of the soda-lime-silica glass. The annealing point of soda-lime-silica glass usually lies within the range of 510° C. to 550° C. and the strain point of soda-lime-silica glass usually lies within the range of 470° C. to 500° C. Moreover, any of a variety of coatings may be applied to the surface of the glass container 10 either before (hot-end coating(s)) or after (cold-end coating(s)) annealing.

There thus has been disclosed a method of manufacturing glass containers with permanent, integral, and randomized streaks of color that satisfies one or more of the objects and aims previously set forth. The disclosure has been presented in conjunction with several illustrative embodiments, and additional modifications and variations have been discussed. Other modifications and variations readily will suggest themselves to persons of ordinary skill in the art in view of the foregoing discussion. For example, the subject matter of each of the embodiments is hereby incorporated by reference into each of the other embodiments, for expedience. The disclosure is intended to embrace all such modifications and variations as fall within the spirit and broad scope of the appended claims.

1. A method of manufacturing a glass container, the method comprising:
melting a batch material, which contains cullet, to produce molten glass having a soda-lime-silica chemical composition;
delivering a flow of molten glass to a forehearth that comprises an elongated housing and a glass feeder appended to the elongated housing, the elongated housing defining a conditioning compartment, and wherein the flow of molten glass flows through the conditioning compartment of the forehearth from an inlet to an outlet along a flow direction and then enters a spout chamber of the glass feeder;
conditioning the flow of molten glass within the conditioning compartment of the forehearth including reducing a temperature of the flow of molten glass such that the temperature of the flow of molten glass at the outlet of the conditioning compartment is less than the temperature of the flow of molten glass at the inlet of the conditioning compartment;
introducing colored cullet into the flow of molten glass, the colored cullet producing colored striations that do not fully mix and assimilate into the flow of molten glass;
discharging an output of conditioned molten glass from the glass feeder of the forehearth; and
forming a glass container from the output of conditioned molten glass, the glass container comprising a glass substrate that defines the shape of the container and includes random streaks of color.

2. The method set forth in claim 1, wherein melting the batch material comprises introducing the batch material into a melting chamber of a glass furnace onto a molten glass bath.

3. The method set forth in claim 2, further comprising:
flowing the molten glass bath from the melting chamber of the glass furnace to a fining chamber of the glass furnace through a submerged throat, and wherein delivering the flow of molten glass to the forehearth comprises delivering the flow of molten glass from the fining chamber of the glass furnace to the conditioning compartment of the forehearth.

4. The method set forth in claim 1, wherein the colored cullet is composed of solid cullet particles that are unicolored.

5. The method set forth in claim 1, wherein the colored cullet comprises solid cullet particles that are multicolored.

6. The method set forth in claim 1, wherein the colored cullet is composed of premelted molten cullet.

7. The method set forth in claim 1, wherein the elongated housing includes a trough, which defines an elongated channel along which the flow of molten glass flows, and a roof, wherein the roof includes a pair of laterally spaced projections that extend downward from the roof and divide an open space above the flow of molten glass into a central section and two side sections, and wherein introducing the colored cullet into the flow of molten glass comprises introducing the colored cullet into the flow of molten glass through the central section between the pair of laterally spaced projections.

8. The method set forth in claim 1, wherein the output of conditioned molten glass discharged from the forehearth is discharged from the glass feeder of the forehearth in the form of at least one conditioned molten glass gob.

9. A method of manufacturing a glass container, the method comprising:
introducing a batch material, which contains cullet, into a melting chamber of a glass furnace, the batch material being introduced onto a molten glass bath that comprises soda-lime-silica glass and melting into the molten glass bath;
flowing the molten glass bath from the melting chamber of the glass furnace to a fining chamber of the glass furnace through a submerged throat;
delivering a flow of molten glass from the fining chamber of the glass furnace to a forehearth connected to the glass furnace, the forehearth comprising an elongated housing and a glass feeder appended to the elongated housing, the elongated housing of the forehearth defining a conditioning compartment, and wherein the flow of molten glass flows from an inlet of the conditioning compartment to an outlet of the conditioning compartment along a flow direction and then enters the glass feeder;
conditioning the flow of molten glass within the conditioning compartment of the forehearth including reducing a temperature of the flow of molten glass such that the temperature of the flow of molten glass at the outlet of the conditioning compartment is less than the temperature of the flow of molten glass at the inlet of the conditioning compartment;
introducing colored cullet into the flow of molten glass, the colored cullet comprising solid cullet particles that produce colored striations within the flow of molten glass;
discharging at least one gob of conditioned molten glass from the glass feeder of the forehearth; and
forming a glass container from the gob of conditioned molten glass, the glass container comprising a glass substrate that defines the shape of the container and includes and axially-closed base and a circumferential wall extending from a periphery of the axially-closed base, and wherein at least the circumferential wall of the glass substrate includes integral random streaks of color.

10. The method set forth in claim 9, wherein the colored cullet is composed of solid cullet particles that are unicolored.

11. The method set forth in claim 9, wherein the colored cullet comprises solid cullet particles that are multicolored.

12. The method set forth in claim 9, wherein the elongated housing includes a trough, which defines an elongated channel along which the flow of molten glass flows, and a roof, wherein the roof includes a pair of laterally spaced projections that extend downward from the roof and divide an open space above the flow of molten glass into a central section and two side sections, and wherein introducing the colored cullet into the flow of molten glass comprises introducing the colored cullet into the flow of molten glass through the central section between the pair of laterally spaced projections.

13. The method set forth in claim 9, wherein the elongated housing includes a trough, which defines an elongated channel along which the flow of molten glass flows, and a roof above the trough that defines an auxiliary inlet, and wherein introducing the colored cullet into the flow of molten glass comprises introducing the colored cullet into the flow of molten glass through the auxiliary inlet.

14. The method set forth in claim 9, wherein the glass feeder includes a spout and orifice plate that together define a spout chamber, and further includes a reciprocating plunger aligned with an orifice defined in the orifice plate, and wherein discharging the at least one gob of conditioned molten glass from the glass feeder comprises reciprocating the plunger relative to the orifice plate to control the flow of conditioned molten glass through the orifice as a stream of conditioned molten glass and shearing the stream of conditioned molten glass to provide the gob of conditioned molten glass.
